(19) United States
(12) Patent Application Publication
(10) Pub. No.: US 2013/0036272 A1
(43) Pub. Date: Feb. 7, 2013

(54) STORAGE ENGINE NODE FOR CLOUD-BASED STORAGE

(71) Applicant: Steven Boyd Nelson, Auburn, WA (US)

(72) Inventor: Steven Boyd Nelson, Auburn, WA (US)

(73) Assignee: Microsoft Corporation, Redmond, WA (US)

(21) Appl. No.: 13/195,848

(22) Filed: Aug. 2, 2011

(51) Int. Cl. G06F 12/00

(52) U.S. Cl. 711/147; 711/E12.001

(57) ABSTRACT

A system includes a storage engine node that includes a processor and a memory coupled to the processor. The memory stores a protocol mapper executable by the processor to convert storage access requests from a local storage protocol to a cloud storage protocol.

### BACKGROUND

Enterprises often use dedicated storage to centrally store data. For example, data may be stored in a hardware-based storage system or a server located at the enterprise. As computer architectures increase in complexity (e.g., 32-bit, 64-bit, etc.), a total amount of addressable memory also increases. For example, a 64-bit architecture may address over two billion terabytes of memory. However, the size of storage systems is limited by physical and performance considerations. Specifically, the amount of physical space required to hold the amount of disk storage that can be addressed by a 64-bit architecture would require somewhere on the order of 1 billion physical disk drives. However, long before the storage could be installed physically, the performance characteristics of the physical storage would render the storage unusable.

### SUMMARY

Systems and methods of cloud-based storage using one or more storage engine nodes are disclosed. For example, a storage engine node may be used to extend (e.g., supplement) local storage with cloud-based storage. In addition, multiple storage engine nodes may be used to form a storage network that provides load-balanced access to cloud-based storage. The storage engine nodes may abstract input and output functionality via protocol mappers that convert between one or more native or local storage protocols and one or more cloud storage protocols. The storage engine nodes may enable use of cloud-based storage to form a distributed, scalable storage system whose size may approach or reach the bounds of a large address space (e.g., a 64-bit address space or a 128-bit address space). The system provides the ability to extend memory space so that the overall size of the addressable storage can be increased by using a virtualized environment, such as cloud appliances/storage, which can be extended arbitrarily.

### BRIEF DESCRIPTION OF THE DRAWINGS

The present disclosure may be better understood, and its numerous features and advantages made apparent to those skilled in the art, by referencing the accompanying drawings.

FIG. 1 is a diagram to illustrate a particular embodiment of a system including a storage engine node for cloud-based storage;

FIG. 2 is a diagram to illustrate a particular embodiment of a system including multiple storage engine nodes for cloud-based storage;

FIG. 3 is a diagram to illustrate another particular embodiment of a system including a storage engine node for cloud based storage;

FIG. 4 is a diagram to illustrate a particular embodiment of a load balanced system including multiple storage engine nodes;

FIG. 5 is a diagram to illustrate another particular embodiment of a load balanced system including multiple storage engine nodes;

FIG. 6 is a flowchart to illustrate a particular embodiment of a method of data access using a storage engine node; and

FIG. 7 is a block diagram to illustrate a particular embodiment of a computing environment including a computing device to support systems, methods, and computer program products described in FIGS. 1-5.

The use of the same reference symbols in different drawings indicates similar or identical items.

### DETAILED DESCRIPTION

In accordance with disclosed systems and methods, a storage engine node may enable the use of cloud-based storage to implement storage for local devices (e.g., at an enterprise). The storage engine node may include one or more protocol mappers to convert between local storage protocols and cloud storage protocols. The storage engine node may also implement an index-based (e.g., pointer-based) operating system. For example, a storage engine node of a storage network may include a memory segment storing an index. When the storage engine node receives a request to write data, the storage engine node may determine whether a signature corresponding to the data is found in the index.

In a single node embodiment, a storage engine node has two protocol converters (e.g. a representational state transfer (REST)-based protocol to/from a common internet file system (CIFS)-based protocol/a network file system (NFS)-based protocol; a small computer system interface (SCSI)-based protocol/a fiber channel (FC)-based protocol to/from a representational state transfer (REST)-based protocol), a storage engine operating system, and a memory assigned to a cloud appliance. The storage engine node may also include a native protocol interface. In this embodiment, the storage engine node operates autonomously from other storage units.

In a multi-node embodiment, there are N nodes (where N is an integer greater than one), and all of the nodes share the same memory segment that spans all nodes. A load balancer provides a mechanism to assign user requests to each node for processing of a particular data stream. Each node maintains its own protocol converters, optional native protocol interfaces, and copies of the storage operating system.

In a matrix embodiment, a series of multi-node implementations are provided, with a master “selection” index maintained at a load balancer. This allows portions of a main index to be stored within different multi-node implementations, with a range index maintained on the load balancer (or a series of load balancers configured in a multi-node configuration).

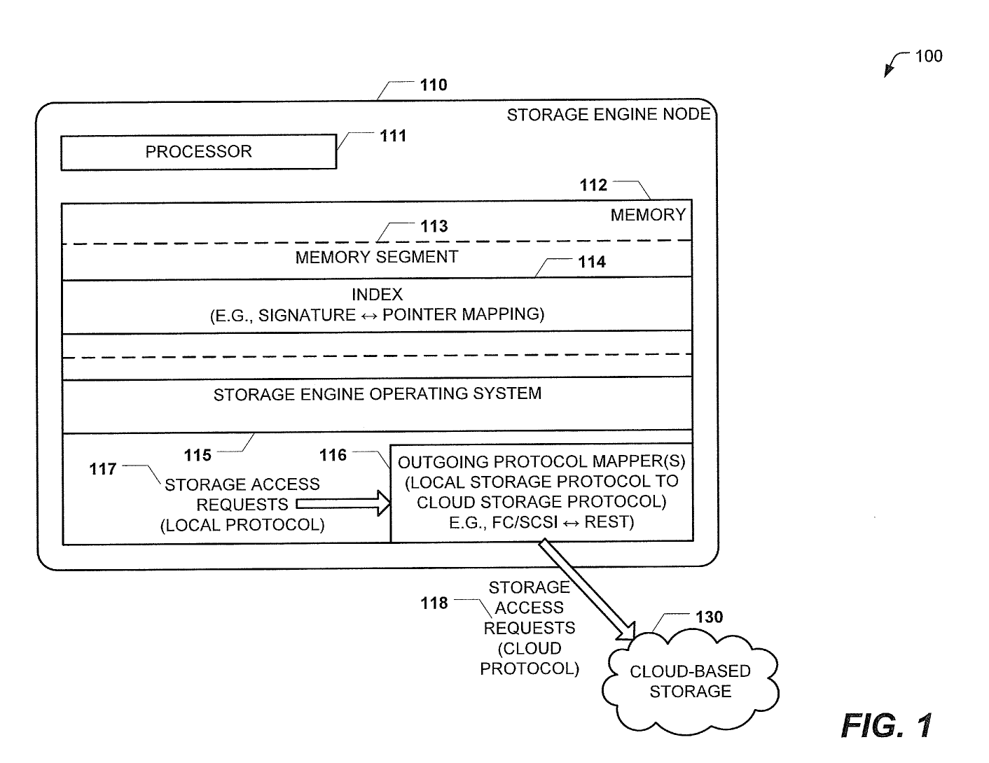

Referring to FIG. 1, a particular embodiment of a system 100 is shown. The system 100 includes a storage engine node 110. The storage engine node 110 includes a processor 111 and a memory 112 coupled to the processor 111. The storage engine node 110 is coupled to cloud-based storage 130 and may facilitate access to the cloud-based storage 130.

The memory 112 at the storage engine node 110 stores a protocol mapper 116 that is executable by the processor 111 to convert storage access requests, such as illustrative storage access requests 117, from a local storage protocol to a cloud storage protocol, or vice versa, to generate converted storage access requests 118. Storage access requests may include data write requests, data read requests, or any combination thereof For example, the converted storage access requests 118 may be in a cloud-based protocol (e.g. a representational state transfer (REST)-based protocol) to access the cloud-based storage 130. The memory 112 also includes a memory segment 113. The memory segment 113 stores an index 114 (e.g. a de-duplication index). The memory segment 113 may be combined with memory segments of other storage engine nodes to form a logical segment that stores a storage operating system data location index.

The memory 112 further includes a storage engine operating system that may include an indexing system. The storage system operating system is executable by the processor 111. In a particular example, an index of the indexing system may be a pointer-based storage operating system data location index, where each entry of the index maps a signature of data stored at a particular storage location to a pointer to the particular storage location. The particular storage location may be located at a remote storage device (e.g., a remote storage device that is part of the cloud-based storage 130). The pointers stored in the index may correspond to addresses of an address space. For example, the address space may span across multiple underlying remote storage devices of the cloud-based storage 130. In a particular embodiment, the cloud-based storage 130 may be accessible via one or more cloud storage services (e.g., services that enable data storage and sharing via one or more networks of distributed, Internet-accessible storage servers). It will be appreciated that by spreading an address space across the cloud-based storage 130, overall utilization of the address space (e.g., a 64-bit address space or a 128-bit address space) may be increased.

In a particular illustrative embodiment, the local storage protocol is a fiber channel (FC)-based protocol, a small computer system interface (SCSI)-based protocol, a transport control protocol/internet protocol (TCP/IP)-based protocol, a common internet file system (CIFS)-based protocol, a network file system (NFS)-based protocol, a serial attached SCSI (SAS)-based protocol, or a combination thereof. The cloud-based storage protocol may be a REST-based protocol.

For example, the protocol mapper 116 of the first storage engine node 110 may receive the storage access requests 117 in a local protocol (e.g. FC and/or SCSI), and the protocol mapper 116 may convert the storage access requests 117 from the local protocol to a cloud-based protocol (e.g., a REST-based protocol).

During operation, the system 100 of FIG. 1 may enable local storage access requests (e.g., the storage access requests 117) to be completed or acted upon via the cloud-based storage 130. The storage access requests 117 may be requests to read data, requests to write data, or any combination thereof. For example, a particular storage access request received at the first storage engine node 110 may be a request to write data. The storage engine operating system 115 may compute a signature of the data to be written and may determine whether the computed signature is found in a stored index at the shared memory segment 113. If the signature is found in the index, the storage engine operating system 115 may discard the storage access request to avoid duplication of the data at the cloud-based storage 130. If the signature is not found in the index, the protocol mapper 116 may convert the storage access request to a cloud-based protocol and may forward the converted storage access request to the cloud-based storage 130. Once the data is successfully written at the cloud-based storage 130, the signature of the data and a pointer to a corresponding storage location may be added to the index. When a request to read data is received, the storage engine node 110 may convert the read request (which may specify a requested address or address range in the cloud-based storage 130) to the cloud-based storage protocol and may forward the converted read request to the cloud-based storage 130.

The system 100 of FIG. 1 may provide a distributed, scalable storage system that is not limited by the amount of physical storage space available at a single node or location.

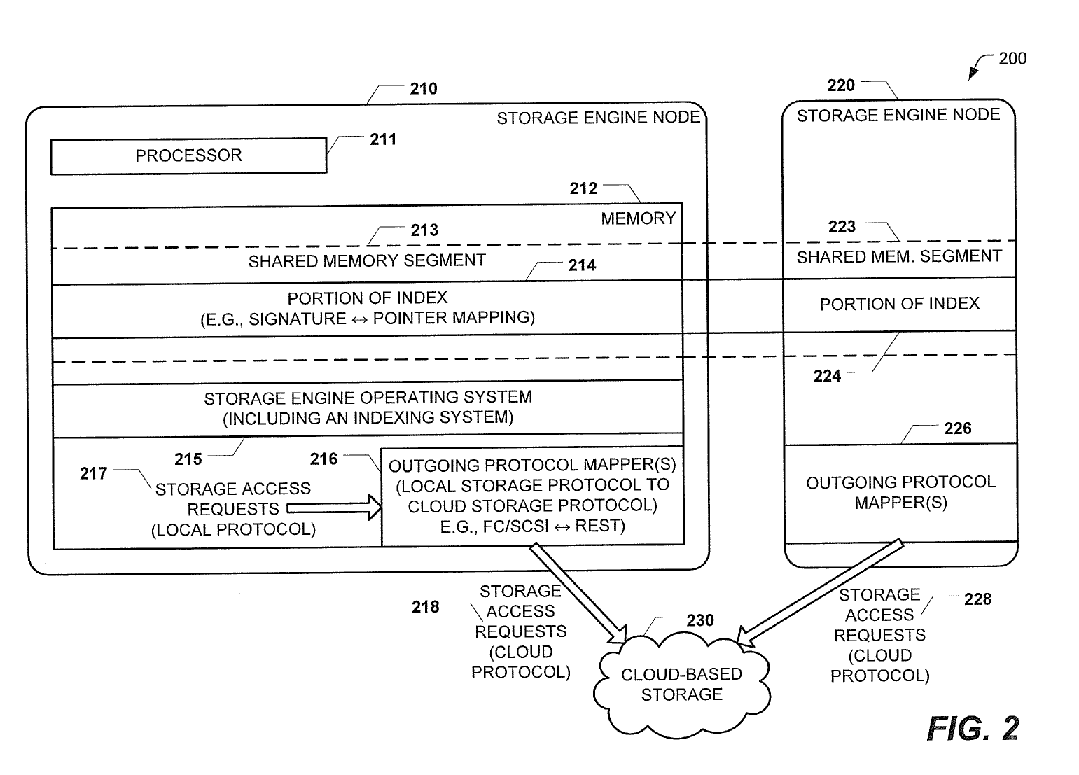

Referring to FIG. 2, a particular embodiment of a system 200 is shown. The system 200 includes a first storage engine node 210 and a second storage engine node 220. The first storage engine node 210 includes a processor 211 and a memory 212 coupled to the processor 211. The second storage engine node 220 may also include a processor and a memory (not shown). The first storage engine node 210 and the second storage engine node 220 may be coupled to cloud based storage 230 and may facilitate access to the cloud-based storage 230.

The memory 212 at the first storage engine node 210 stores a protocol mapper 216 that is executable by the processor 211 to convert storage access requests, such as illustrative storage access requests 217, from a local storage protocol to a cloud storage protocol, or vice versa, to generate converted storage access requests 218. For example, the converted storage access requests 218 may be in a cloud-based protocol to access the cloud-based storage 230. The memory 212 also includes a shared memory segment 213. The shared memory segment 213 may be combined with other memory segments of other storage engine nodes to form a logical segment that stores a storage operating system data location index. For example, a second portion 224 of the storage operation system data location index may be stored within a second shared memory segment 223 at the second storage engine node 220, as illustrated in FIG. 2. Thus, the index may be stored collectively by a combination of the first shared memory segment 213 and the second shared memory segment 223. Each such shared memory segment may be stored at a distinct storage engine node.

The memory 212 further includes a storage engine operating system that may store or include an indexing system. In a particular example, the indexing system 215 is executable by the processor 211 to perform data de-duplication based on the index. The index may be a pointer-based storage operating system data location index, where each entry of the index maps a signature of data stored at a particular storage location to a pointer to the particular storage location. The particular storage location may be located at a remote storage device (e.g., a remote storage device that is part of the cloud-based storage 230). The pointers stored in the index may correspond to addresses of a shared address space. For example, the shared address space may span across multiple underlying remote storage devices of the cloud-based storage 230. In a particular embodiment, the cloud-based storage 230 may be accessible via one or more cloud storage services (e.g., services that enable data storage and sharing via one or more networks of distributed, Internet-accessible storage servers). It will be appreciated that by spreading an address space across the cloud-based storage 230, overall utilization of the address space (e.g., a 64-bit address space or a 228-bit address space) may be increased.

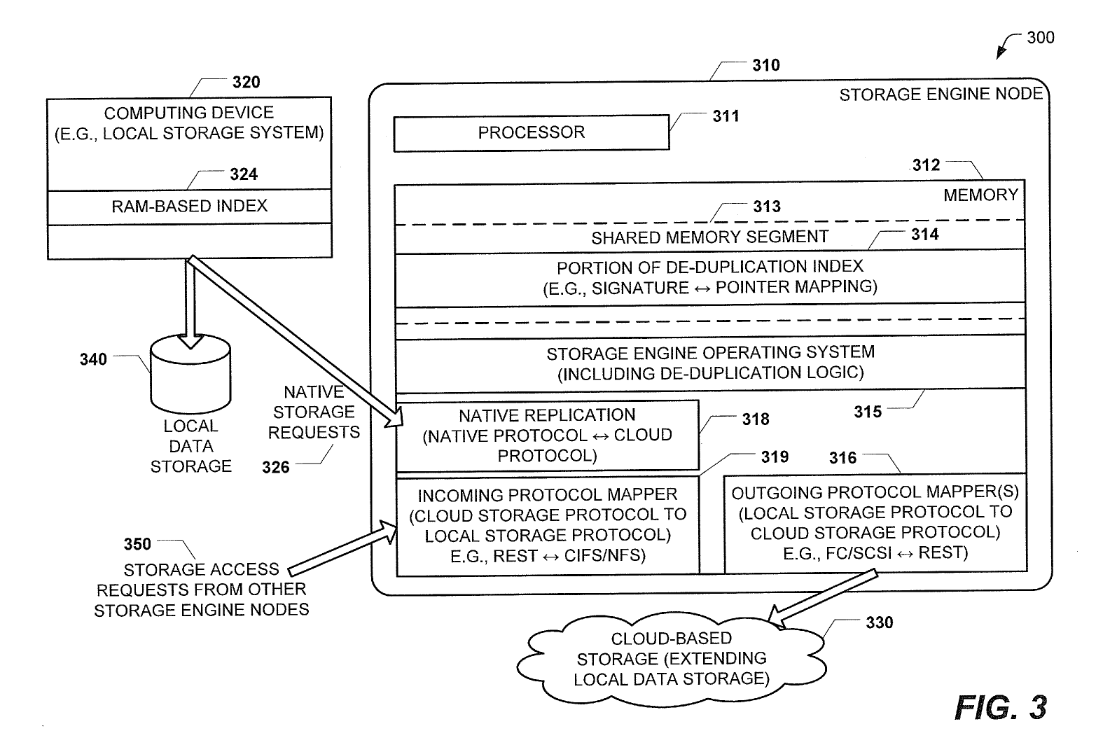

The second storage engine node 220 includes a second protocol mapper 226 that converts storage access requests from a local storage protocol to a cloud storage protocol to generate converted storage access requests 228. The first storage engine node 120 and the second storage engine node 220 may each independently send cloud-protocol storage access requests 218, 228 to the cloud-based storage 230, where the cloud-protocol storage access requests 218, 228 are based on local requests received from users or computing devices, as further described with reference to FIGS. 3-7. Storage access requests may include data write requests, data read requests, or any combination thereof.

In a particular illustrative embodiment, the local storage protocol is a fiber channel (FC)-based protocol, a small computer system interface (SCSI)-based protocol, a transport control protocol/internet protocol (TCP/IP)-based protocol, a common internet file system (CIFS)-based protocol, a network file system (NFS)-based protocol, a serial attached SCSI (SAS)-based protocol, or a combination thereof The cloud-based storage protocol may be a representational state transfer (REST)-based protocol.

For example, the protocol mapper 216 of the first storage engine node 210 may receive the storage access requests 217 in a local protocol (e.g. FC and/or SCSI), and the protocol mapper 216 may convert the storage access requests 217 from the local protocol to a cloud-based protocol (e.g., a REST-based protocol). The protocol mapper 226 of the second storage engine node 220 may operate in a similar manner as the protocol mapper 216 in the first storage engine node 210.

During operation, the system 200 of FIG. 2 may enable local storage access requests (e.g., the storage access requests 217) to be completed or acted upon via the cloud-based storage 230. The storage access requests 217 may be requests to read data, requests to write data, or any combination thereof The system 200 may also perform indexing with respect to the cloud-based storage 230. For example, a particular storage access request received at the first storage engine node 210 may be a request to write data. The indexing system of the storage engine operating system 215 may compute a signature of the data to be written and may determine whether the computed signature is found in the index that is collectively stored at the shared memory segments 213, 223. In a particular example, if the signature is found in the index, the indexing system of the storage engine operating system 215 may discard the storage access request to avoid duplication of the data at the cloud-based storage 230. If the signature is not found in the index, the protocol mapper 216 may convert the storage access request to a cloud-based protocol and may forward the converted storage access request to the cloud-based storage 230. Once the data is successfully written at the cloud-based storage 230, the signature of the data and a pointer to a corresponding storage location may be added to the index. When a request to read data is received, the storage engine node 210 may convert the read request (which may specify a requested address or address range in the cloud-based storage 230) to the cloud-based storage protocol and may forward the converted read request to the cloud-based storage 230.

In a particular embodiment, the reduction of storage space usage achieved due to indexing may accelerate as the total amount of data managed by the storage engine nodes 210, 220 increases. The system 200 of FIG. 2 may thus provide a distributed, scalable storage system that is not limited by the amount of physical storage space available at a single location.

Referring to FIG. 3, a particular illustrative embodiment of a system 300 operable to extend local data storage 340 with cloud-based storage 330 is shown. The system 300 may be a storage system used as a replication or storage extension target. The storage system 300 (system array) may replicate LUNs or disk blocks to the cloud system via REST to a target. If the target is utilizing the same storage operating system, then the semantics of the transfer can be managed by toolsets. Disk blocks may be replicated to a cloud storage engine node that runs the storage operating system. However, when using ‘native’ (vendor specific) replication protocols, the replication may be managed via a vendor specific toolset between a physical storage array and the cloud based storage engine.

For storage extension, a storage vendor may provide a mechanism by which to relocate LUNs or disk blocks to other pieces of storage that are remote to the original physical piece of storage. The source storage typically leaves a marker to identify the moved block and the location within the operating system. When used in this way, the cloud storage engine could be used either as a generic target (as in the replication function using the REST protocol), or as a vendor specific target (using vendor specific protocols and semantics).

The computing device 320 may be communicatively coupled to a storage engine node 210 and may include a random access memory (RAM)-based index 324. For example, the RAM-based index 324 may provide pointer-based de-duplication functionality with respect to the local data storage 340. An example of the local data storage 340 may include, but is not limited to, one or more disk-based storage devices, such as hard drives or solid state drives.

The storage engine node 310 includes a processor 311 and a memory 312. The processor 311 may be similar to the processor 211 of the first storage engine node 210 in FIG. 2. The memory 312 may be similar to the memory 212 of the first storage engine node 210 of FIG. 2. The memory 312 includes a shared memory segment 313 that includes a portion of a de-duplication index 314. The shared memory segment 313 may be similar to the shared memory segment 213 of FIG. 2. The memory 312 further includes a storage engine operating system including de-duplication logic 315, which may function as described with reference to the de-duplication logic 215 of FIG. 2.

In a particular embodiment, the memory 312 of the storage engine node 310 may further include an incoming protocol mapper 319 and an outgoing protocol mapper 316. The outgoing protocol mapper 316 may be similar to the protocol mapper 216 of FIG. 2. The incoming protocol mapper 319 may be executable by the processor 311 to convert storage requests 350 from other storage engine nodes (not shown) from a cloud storage protocol to a local storage protocol. Examples of cloud to local protocol conversion include conversion from REST to CIFS/NFS.

The incoming protocol mapper (REST to/from CIFS/NFS) is used to facilitate connections from Internet sources (replication, etc.) that would like to access the services of the storage engine, either in the single node or multi-node variety. This protocol mapper converts the REST semantics of block and sequence to either CIFS SMB streams or NFS RPC data streams on ingest (client writes) and reverses the process during egress (client reads). This function is provided as a bridge to existing storage operating systems to provide a software bridge that allows a vendor to install the storage operating system within a cloud appliance with few, if any, changes to their code base. For instance, access request 350, using a REST based data transport mechanism, would be able to access a storage operating system that does not natively provide the ability to receive REST data transfers, as the conversion between REST and either of the two of the other data protocols would be handled at the network layer, prior to the data being received by the storage operating system.

During operation, the computing device 320 may transmit storage access requests to the local data storage 340, as shown. In a particular embodiment, the amount of addressable memory provided by the local data storage 340 may be smaller than a maximum amount of memory addressable via an address space supported by the computing device 320. Alternatively or in addition, a management decision may be made to replicate data to “lower cost” storage, e.g. cloud storage, that represents a large pool of storage that does not require physical space constraints, from the perspective of the client. Native replication logic 318 at the storage engine node 310 may be used to extend the local data storage 340 with the cloud-based storage 330.

For example, when requested storage locations correspond to the cloud-based storage 330 and not the local data storage 340, the computing device 320 may transmit native (e.g., local protocol) storage requests 326 to the storage engine node 310. A format of the native storage requests 326 may be based on characteristics of the computing device 320 (e.g., based on a vendor, an operating system, etc. associated with the computing device 320). The native replication logic 318 may be executable by the processor 311 to convert the native storage requests 326 from a native protocol to a cloud-based protocol, so that the requested storage locations may be accessed at the cloud-based storage 330.

As described above, the RAM-based index 324 may provide storage operating system index functionality with respect to the local data storage 340. When the cloud-based storage 330 is used to extend the local data storage 340, in a particular illustrative example, the de-duplication logic 315 may provide de-duplication functionality with respect to the cloud-based storage 330.

By abstracting differences between native protocols and cloud-based protocols, the native replication logic 318 may enable the computing device 320 to natively write data to and read data from the cloud-based storage 330. Thus, from the perspective of the computing device 320, the cloud-based storage 330 may appear as a physical extension of the local data storage 340. For example, the local data storage 340 may correspond to a first portion of an address space and the cloud-based storage 330 may correspond to a second, non-overlapping portion of the same address space.

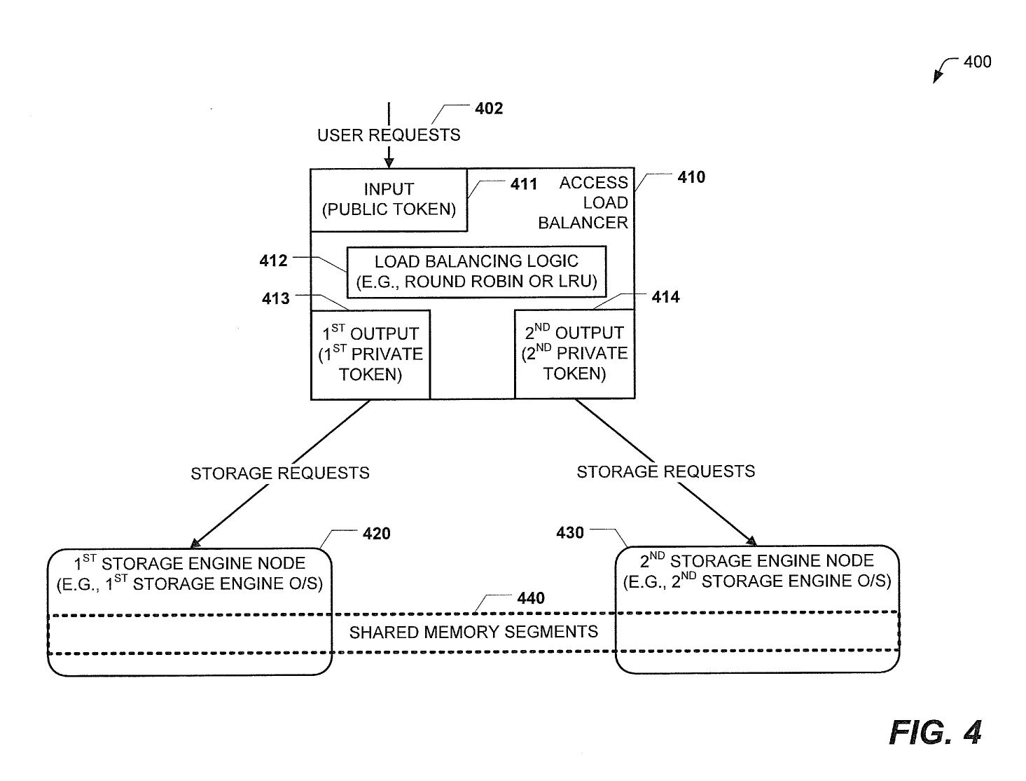

Referring to FIG. 4, a particular illustrative embodiment of a load balanced storage system 400 is shown. The system 400 includes an access load balancer 410, a first storage engine node 420, and a second storage engine node 430. In an illustrative embodiment, the storage engine nodes 420, 430 may include components and functionality similar to the storage engine nodes 210, 220 of FIG. 2 and the storage engine node 310 of FIG. 3. For example, the storage engine nodes 420, 430 may include shared memory segments 440.

In a particular embodiment, the first storage engine node 420 and the second storage engine node 430 may each execute a common storage engine operating system. For example, the common storage engine operating system may be a clustered computing operating system. In another embodiment, the first and second storage engine nodes 420, 430 may execute different operating systems. Multiple running copies of one or more storage engine operating systems may have access to the shared memory segments 440 and may perform data de-duplication based on a common pointer-based index.

The access load balancer 410 may be responsive to user requests 402 (e.g., requests to write data, requests to read data, or any combination thereof). The access load balancer 410 may include an input 411, load balancing logic 412, a first output 413, and a second output 414. The first input 411 may receive the user requests 402, and the user requests may be associated with or include a public token.

The load balancing logic 412 may map the public token to a particular private token associated with a particular output of the access load balancer 410. For example, such mapping may be performed based on one or more load balancing logic routines or methods, such as round robin or least recently used (LRU). To illustrate, the load balancing logic 412 may map the public token to a first private token associated with the first output 413 or to a second private token 414 associated with the second output. As illustrated in FIG. 4, each of the outputs 413, 314 may be coupled to a different storage engine node 420, 430. The load balancing logic 412 may route the user request 402 to the first output 343 or to the second output 414 based on the mapping.

While two outputs are shown in FIG. 4, it should be understood that more than two outputs may be provided by the access load balancer 410 and a load balancer may be coupled to additional storage engine nodes. The load balancer 340 may selectively route access requests to individual storage engine nodes based on a load balancing scheme, reducing an overall data access latency of a storage system that includes cloud-based storage (e.g., because access requests may be selectively routed to an available storage engine node instead of being queued at a busy storage engine node).

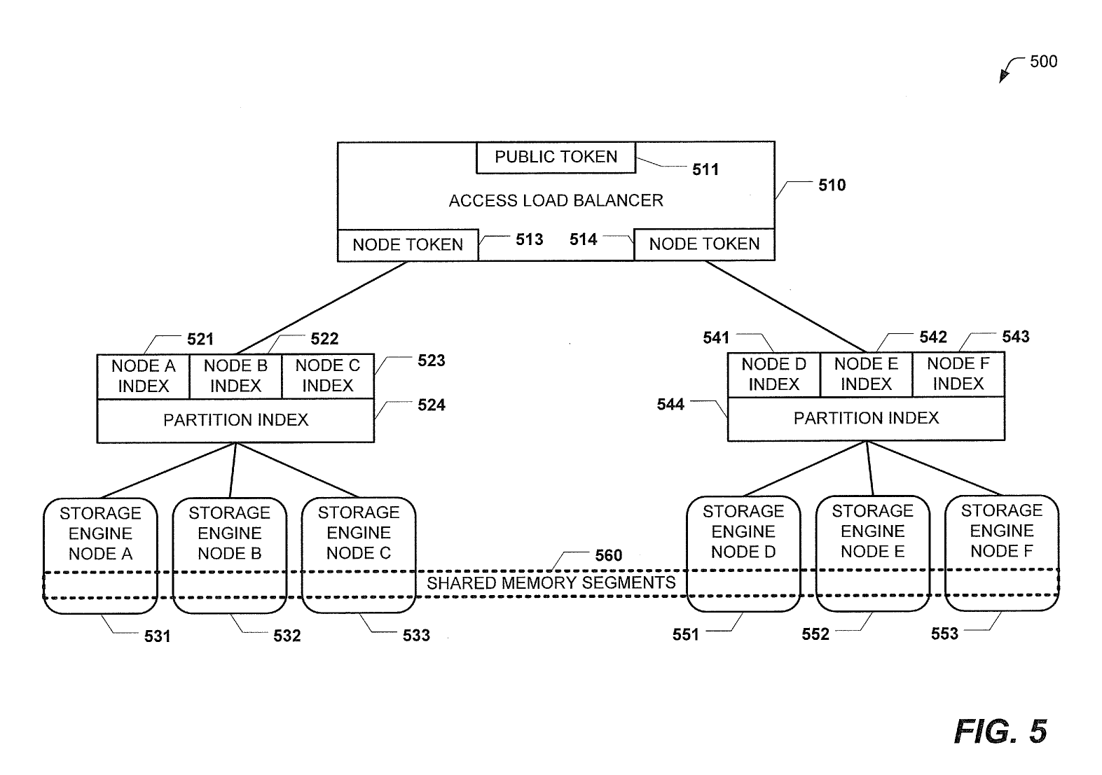

Referring to FIG. 5, a particular illustrative embodiment of a distributed storage system 500 is shown. The distributed storage system 500 includes an access load balancer 510, a first partition index 524, a second partition index 54, and a plurality of storage engine nodes. For example, a first storage engine node 531, a second storage engine node 532, and a third storage engine node 533 may be coupled to the first partition index 524, which in turn may be coupled to the access load balancer 510. Similarly, representative fourth, fifth, and sixth storage engine nodes 551, 552, and 553 may be coupled to the second partition index 544, which in turn may be coupled to the access load balancer 510. The various storage engine nodes 531-533 and 5451-553 may include shared memory segments 560 (e.g., collectively storing a de-duplication index). In a particular embodiment, node indexes 521-523 and 541-5443 corresponding to the storage engine nodes 531-533 and 5451-553 may be accessible to the corresponding partition indexes 524, 544, as illustrated.

A series of multi-node implementations may form a system with a master “selection” index maintained at the load balancer. This would allow portions of the main index to be stored within different multi-node implementations, with the range index maintained on the load balancer (or series of load balancers configured in a multi-node configuration).

In a particular disconnected indexing scheme, each set of multi-node groups of engines would be independent of the index of the others. The range of possible index addresses would be computed (e.g., using a fixed method of calculation with a known address space). The number of desired multi-node implementations (e.g. stripes) would be determined Each stripe would be assigned a portion of the computed index space to manage the use of the access load balancer 510 that maintains a master location table where each portion of the index address space is assigned. This master location table does not contain the full index, but does contain enough of the address to determine which stripe block requests should be sent to. The shared memory segment would be limited to the set of nodes that managed the section of the index previously assigned by the access load balancer 510. This would allow extension of indexes to sizes that grow beyond the limitations of a single shared memory segment, for instance the use of a 128-bit index in a 64-bit address space. The master location index may be located in the access load balancer 510. The access load balancer 510 in this case would also have a specialized copy of the storage operating system installed to allow for pre-calculation of the address spaces based on inbound data to be stored or location of the appropriate stripe based on an inbound request. The access load balancer 510 has a “meta-filesystem” or location table with meta-information regarding potential locations of the blocks that are being requested as part of a store of information.

In another implementation, the shared memory segment spans all nodes that store active data. In this implementation, the effect is similar to having a multi-layered load balancer. The master load balancer 510 maintains state for all sub load balancers—encompassing elements 521-524 and 541-544. Each of these sub load balancers would take requests and pass them to the storage nodes under their control. This configuration would be used in areas where a single set of multi-node engines would not be able to provide adequate response times.

As described with reference to the access load balancer 410 of FIG. 4, the access load balancer 510 may receive requests based on a public token 511. The access load balancer 450 may map the public token to either a first node token 513 or to a second node token 514. The first node token 513 may be routed to a first group of storage engine nodes 531-533 corresponding to the first partition index 524. Similarly, the second node token 514 may be routed to a second group of storage engine nodes 551-553 corresponding to the second partition index 544. Thus, by using multiple partition indexes, load balancing may be performed at multiple levels, leading to further scaling by use of a hierarchical arrangement of storage engine nodes as shown in FIG. 5.

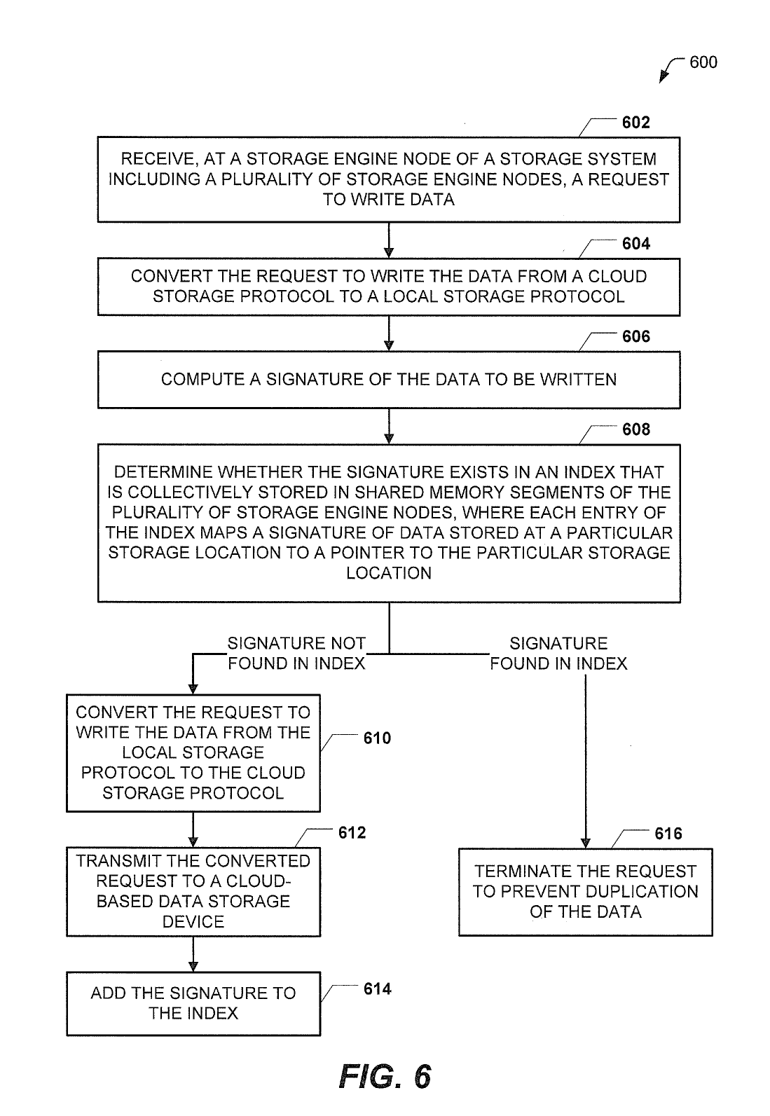

Referring to FIG. 6, a particular embodiment of a method 600 is shown. In an illustrative embodiment, the method 600 may be performed at the system 100 of FIG. 1, the system 200 of FIG. 2, the system 300 of FIG. 3, the system 400 of FIG. 4, the system 500 of FIG. 5, or components thereof.

The method 600 includes receiving a request to write data at a storage engine node of a storage system that includes a plurality of storage engine nodes, at 602. For example, in FIG. 1, the storage engine node 110 may receive a request to write data. The method 600 further includes converting the request to write data from a local storage protocol to a cloud storage protocol (or vice versa), at 604. For example, in FIG. 1, the protocol mapper 116 may convert the request to write data from a local storage protocol (e.g., FC/SCSI) to a cloud storage protocol (e.g., a REST-based protocol) or vice versa.

The method further includes computing a signature of the data to be written, at 606, and determining whether the signature is found in an index, at 608. The index may be collectively stored in shared memory segments of the plurality storage engine nodes. Each entry of the index may map a signature of data stored at a particular storage location to a pointer to the particular storage location. For example, in FIG. 1, the storage engine operating system 115 may compute a signature of the data to be written and may determine whether the signature is found in an index.

If the signature is not found in the index, then the method 600 may proceed to convert the request to write the data from the local storage protocol to the cloud storage protocol, at 610. The method 600 may then transmits the converted request to a cloud-based storage device, at 612, and may add the signature to the index, at 614. Alternatively, if the signature is found in the index (i.e., the data to be written already exists in cloud-based storage), the method 600 may terminate the request (e.g. to prevent duplication of the data), at 616.

The method 600 may be performed each time a data request to write data is received. For example, the method 600 may be performed at a particular storage engine node after the request to write data is routed to the particular storage engine node by an access load balancer (e.g., the access load balancer 410 of FIG. 4 or the access load balancer 510 of FIG. 5). When a request to read data is received, where the request specifies an address or address range in the cloud-based storage from which the data is to be read, the request may be converted from the local storage protocol to the cloud storage protocol. The converted request may be forwarded to the cloud-based storage.

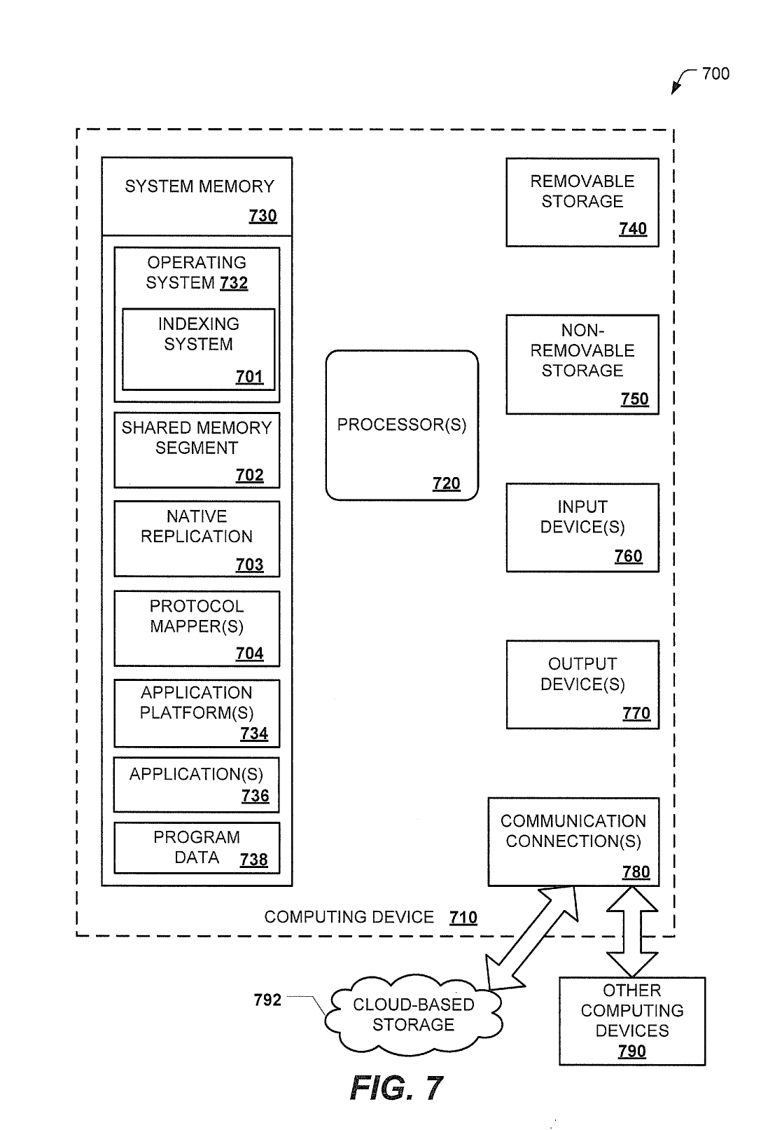

FIG. 7 depicts a block diagram of a computing environment 600 including a computing device 710 operable to support embodiments of systems, methods, and computer program products according to the present disclosure. For example, the system 100 of FIG. 1, the system 200 of FIG. 2, the system 300 of FIG. 3, the system 400 of FIG. 4, the system 500 of FIG. 5, the method 600 of FIG. 6, or components thereof may include, be included within, and/or be implemented by the computing device 710 or components thereof.

The computing device 710 includes at least one processor 720 and a system memory 730. Depending on the configuration and type of computing device, the system memory 730 may be volatile (such as random access memory or “RAM”), non-volatile (such as read-only memory or “ROM,” flash memory, and similar memory devices that maintain stored data even when power is not provided), or some combination of the two. The system memory 730 typically includes an operating system 732, one or more application platforms 734, one or more applications 736 (e.g., represented in the system memory 730 by instructions that are executable by the processor(s) 720), and program data 738.

For example, when the computing device 710 is a storage engine node (e.g., storage engine node 110 of FIG. 1, one of the storage engine nodes, 210, 220 of FIG. 2, the storage engine node 310 of FIG. 3, one of the storage engine nodes 420, 430 of FIG. 4, or one of the storage engine nodes 531-533, 551-553 of FIG. 5), the operating system 732 may be a storage engine operating system that includes an indexing system 701. In an illustrative embodiment, the indexing system 701 may be the indexing system of the storage engine operating system 215 of FIG. 2 or the indexing system of the storage engine operating system 315 of FIG. 32. The system memory 730 may also store a shared memory segment 702 (e.g., corresponding to the shared memory segment 213 or 223 of FIG. 2, the shared memory segment 313 of FIG. 3, one of the shared memory segments 440 of FIG. 4, or one of the shared memory segments 560 of FIG. 5), native replication logic 703 (e.g., corresponding to the native replication logic 318 of FIG. 3), and one or more protocol mappers 704 (e.g., corresponding to the protocol mapper 216 or 226 of FIG. 2 or the protocol mapper 316 or 319 of FIG. 3).

The computing device 710 may also have additional features or functionality. For example, the computing device 710 may include removable and/or non-removable additional data storage devices, such as magnetic disks, optical disks, tape devices, and standard-sized or flash memory cards. Such additional storage is illustrated in FIG. 7 by removable storage 740 and non-removable storage 750. Computer storage media may include volatile and/or non-volatile storage and removable and/or non-removable media implemented in any technology for storage of information such as computer-readable instructions, data structures, program components or other data. The system memory 730, the removable storage 740 and the non-removable storage 750 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 710. Any such computer storage media may be part of the computing device 710. In an illustrative embodiment, one or more of the removable storage 740 and the non-removable storage 750 may be used to implement local data storage, such as the local data storage 340 of FIG. 3.

The computing device 710 may also have input device(s) 760, such as a keyboard, mouse, pen, voice input device, touch input device, motion or gesture input device, etc, connected via one or more wired or wireless input interfaces. Output device(s) 770, such as a display, speakers, printer, etc. may also be connected via one or more wired or wireless output interfaces. The computing device 7610 also contains one or more communication connections 780 that allow the computing device 710 to communicate with other computing devices 790 over a wired or a wireless network. For example, the communication connection(s) 670 may enable communication with cloud-based storage 792, which may correspond to the cloud-based storage 130 of FIG. 1, the cloud-based storage 230 of FIG. 2, or the cloud-based storage 330 of FIG. 3.

It will be appreciated that not all of the components or devices illustrated in FIG. 7 or otherwise described in the previous paragraphs are necessary to support embodiments as herein described. For example, the removable storage 740 may be optional. When the computing device 710 or components thereof is used to implement a storage engine node, the input device(s) 760 and the output device(s) 770 may be optional or not included.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. For example, a calendar application may display a time scale including highlighted time slots or items corresponding to meetings or other events.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system comprising:
a storage engine node comprising:
a processor; and
a memory coupled to the processor, the memory storing:
a protocol mapper executable by the processor to convert storage access requests from a local storage protocol to a cloud storage protocol; and
a shared memory segment that stores a portion of an index, wherein the shared memory segment is one of a plurality of shared memory segments that collectively store the index.

2. The system of claim 1, wherein each of the plurality of shared memory segments is stored at a distinct storage engine node.

3. The system of claim 1, wherein the memory further stores an indexing system executable by the processor to perform indexing with respect to one or more remote data storage devices based on the index.

4. The system of claim 3, wherein each entry of the index maps a signature of data stored at a particular storage location of the one or more remote data storage devices to a pointer to the particular storage location wherein the pointer corresponds to an address of a shared address space corresponding to the one or more remote data storage devices.

5. The system of claim 4, wherein the one or more remote data storage devices are associated with a cloud storage service.

6. The system of claim 1, wherein the storage access requests include write requests, read requests, or any combination thereof.

7. The system of claim 1, wherein the local storage protocol comprises a fiber channel (FC)-based protocol, a small computer system interface (SCSI)-based protocol, a transport control protocol/internet protocol (TCP/IP)-based protocol, a common internet file system (CIFS)-based protocol, a network file system (NFS)-based protocol, a serial attached SCSI (SAS)-based protocol, or any combination thereof.

8. The system of claim 1, wherein the cloud storage protocol comprises a representational state transfer (REST)-based protocol.

9. The system of claim 1, wherein the memory further stores a second protocol mapper executable by the processor to convert storage access requests received from other storage engine nodes from the cloud storage protocol to the local storage protocol.

10. The system of claim 7, wherein the memory further stores native replication logic configured to convert native storage requests to the cloud storage protocol to supplement local data storage associated with a computing device with cloud-based storage.

11. The system of claim 1, further comprising an access load balancer coupled to the storage engine node and to a second storage engine node, wherein the access load balancer comprises:
an input configured to receive a storage request from a user device, wherein the storage request includes a public token associated with the access load balancer;
a first output coupled to the storage engine node, wherein the first output is associated with a first private token that is assigned to the storage engine node;
a second output coupled to the second storage engine node, wherein the second output is associated with a second private token that is assigned to the second storage engine node; and
load balancing logic executable to:
map the public token to the first private token or to the second private token based on a load balancing method; and
route the access request from the input to the first output or to the second output based on the mapping of the public token.

12. The system of claim 11, wherein the load balancing method comprises a round robin method or a least recently used method.

13. The system of claim 11, wherein the storage engine node and the second storage engine node each execute a common storage engine operating system, wherein the common storage engine operating system comprises a clustered computing operating system.

14. The system of claim 11, wherein the storage engine node and the second storage engine node each execute different storage engine operating systems.

15. The system of claim 11, wherein the storage engine node and the second storage engine node are associated with a first partition index that is accessible to the access load balancer, and wherein a third storage engine node and a fourth storage engine node are associated with a second partition index that is accessible to the access load balancer.

16. A method comprising:
receiving, at a storage engine node of a storage system comprising a plurality of storage engine nodes, a request to write data;
computing a signature of the data to be written;
determining whether the signature is found in an index that is collectively stored in shared memory segments of the plurality of storage engine nodes, wherein each entry of the index maps a signature of data stored at a particular storage location to a pointer to the particular storage location; and
when the signature is not found in the index:
converting the request to write the data from a local storage protocol to a cloud storage protocol;
transmitting the converted request to a cloud-based data storage device; and
adding the signature to the index.

17. The method of claim 16, further comprising, when the signature is found in the index, terminating the request to prevent duplication of storage of the data.

18. The method of claim 16, further comprising:
receiving a second request to read data;
converting the second request from the local storage protocol to the cloud storage protocol; and
transmitting the converted second request to the cloud-based data storage device.

19. A system comprising:
a storage engine node comprising:
a processor; and
a memory coupled to the processor, the memory storing:
a protocol mapper executable by the processor to convert storage access requests from a local storage protocol to a cloud storage protocol; and
native replication logic executable by the processor to convert native storage requests to the cloud storage protocol to supplement local data storage associated with a computing device with cloud-based storage.

20. The system of claim 19, wherein the native replication logic is executable by the processor to receive the native storage requests from the computing device, wherein the local data storage corresponds to a first portion of an address space and wherein the cloud-based storage corresponds to a second portion of the address space.
